(19) United States
(12) Patent Application Publication
(10) Pub. No.: US 2012/0077548 A1
(43) Pub. Date: Mar. 29, 2012

(54) Mobile Phone Case

(76) Inventor: Lynne Goldberg, Montreal que (CA)

(21) Appl. No.: 12/891,101

(22) Filed: Sep. 27, 2010

(51) Int. Cl. H04W 88/02

(52) U.S. Cl. 455/567; 455/575.1

(57) ABSTRACT

A mobile phone accessory has an indicating function for receiving an incoming call or SMS to a mobile phone. The mobile phone accessory comprises a housing which is of a shape and size comparable to the mobile phone. The housing has a transparent or translucent plate and a compartment for containment of at least one battery, an incoming call detection circuit and an incoming call indicating light. The incoming call indicating light illuminates and/or flashes when the mobile phone receives the incoming call or SMS.

### FIELD OF THE INVENTION

This invention relates to a mobile phone accessory with an indicating function to indicate an incoming phone call or SMS to a mobile phone. More particularly, this invention relates to a mobile phone case with a light which illuminates and/or flashes when the mobile phone receives an incoming phone call or SMS.

### BACKGROUND OF THE INVENTION

For convenience, the invention and the prior art will be generally discussed below in relation to mobile phone accessories. However, it is to be understood that the invention is not limited to this application.

More and more people nowadays use and carry a mobile phone wherever they are. Often the mobile phone is placed at such a location that phone ring is not easy to be heard, for instance, at a noisy background. As a result, an incoming phone call is missed.

There is therefore a need for a mobile phone accessory that addresses the inadequacies associated with the use of mobile phones.

Accordingly, a mobile phone accessory is provided which accessory may be removably affixed to a mobile phone, in a form of a case or housing, to provide a visual indicating function to indicate an incoming phone call or SMS to the mobile phone.

### SUMMARY OF THE DISCLOSURE

A mobile phone accessory employs an indicating function for receiving an incoming call or short message service (“SMS”) to a mobile phone. The mobile phone accessory comprises a housing which is of a shape and size comparable to the mobile phone. The housing has a transparent or translucent plate, and a compartment for containment of at least one battery, an incoming call detection circuit and an incoming call indicating light.

Preferably, the incoming call indicating light illuminates and/or flashes when the mobile phone receives the incoming call.

It is preferred that the incoming call detection circuit and the incoming call indicating light are located on a printed circuit board.

A cover plate may be provided for protection to the at least one battery, the incoming call detection circuit and the incoming call indicating light.

Preferably, the incoming call indicating light is located adjacent to the transparent or translucent plate such that light emitting from the incoming call indicating light passes through the transparent or translucent plate.

It will be appreciated that the mobile phone accessory of the invention is easily affixed to a mobile phone without the use of any tool or fixing material.

### BRIEF DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In the drawings:

FIG. 1 is a perspective view of an embodiment of a mobile phone accessory;

FIG. 2 is a side view of the mobile phone accessory of FIG. 1, in engagement to a mobile phone; and

FIG. 3 is an exploded perspective view of the mobile phone accessory of FIG. 1.

### DETAILED DESCRIPTION OF THE PREFERRED EMBODIMENTS

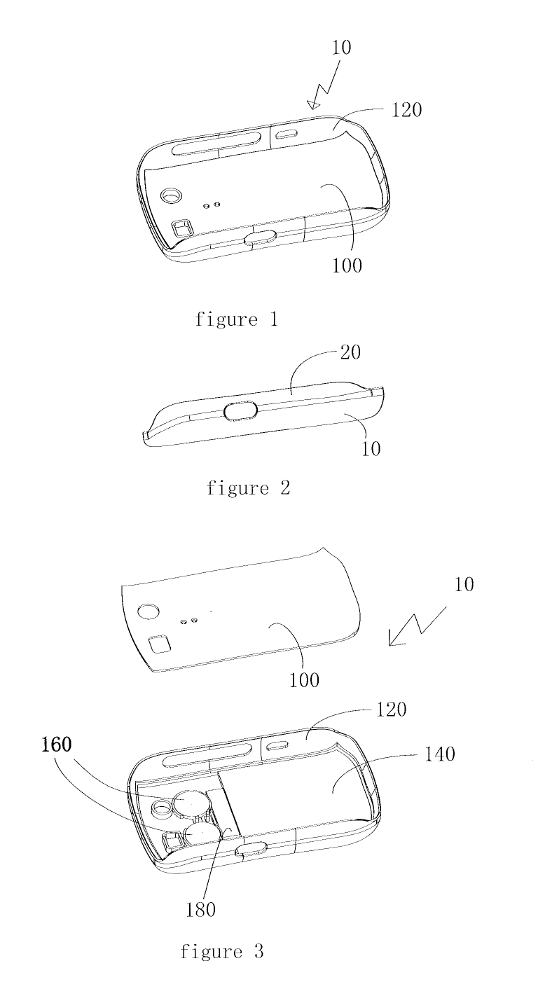

FIG. 1 shows a preferred embodiment of mobile phone accessory 10 comprising housing 120 and cover plate 100 providing protection to batteries 160, incoming call detection circuit and incoming call indicating light (not shown).

Referring to FIGS. 1 and 2, there is presented mobile phone accessory 10 shown affixed to mobile phone 20, of which housing 120 is of a shape and size comparable to mobile phone 20.

Turning to FIG. 3, mobile phone accessory 10 is shown comprising cover plate 100 removed from housing 120. Housing 120 is shown comprising transparent or translucent plate 140 and a compartment for containment of batteries 160 and printed circuit board 180 on which incoming call detection circuit and an incoming call indicating light (not shown) are located.

The incoming call detection circuit is capable of detecting mobile phone signal of 800 MHz, 900 MHz and/or 1800 MHz. when an incoming call or SMS is received by mobile phone 20. When the incoming call detection circuit detects a mobile phone signal, the incoming call detection circuit activates the incoming call indicating light to illuminate and/or flash.

The incoming call indicating light is located adjacent to transparent or translucent plate 140 such that light emitting from the incoming call indicating light passes through transparent or translucent plate 140 and is visual to the mobile phone user.

Throughout the specification and claims the word “comprise” and its derivatives are intended to have an inclusive rather than exclusive meaning unless the context requires otherwise.

It will be appreciated by those skilled in the art that many modifications and variations may be made to the methods of the invention described herein without departing from the spirit and scope of the invention.

1. A mobile phone accessory with an indicating function for receiving an incoming call or SMS to a mobile phone; the mobile phone accessory comprising a housing which is of a shape and size comparable to the mobile phone; the housing having a transparent or translucent plate and a compartment for containment of at least one battery, an incoming call detection circuit and an incoming call indicating light.

2. The mobile phone accessory of claim 1, wherein the incoming call indicating light illuminates and/or flashes when the mobile phone receives the incoming call or SMS.

3. The mobile phone accessory of claim 1, wherein the incoming call detection circuit and the incoming call indicating light are located on a printed circuit board.

4. The mobile phone accessory of claim 2, wherein the incoming call detection circuit and the incoming call indicating light are located on a printed circuit board.

5. The mobile phone accessory of claim 1, wherein a cover plate is provided for protection to the at least one battery, the incoming call detection circuit and the incoming call indicating light.

6. The mobile phone accessory of claim 2, wherein a cover plate is provided for protection to the at least one battery, the incoming call detection circuit and the incoming call indicating light.

7. The mobile phone accessory of claim 3, wherein a cover plate is provided for protection to the at least one battery, the incoming call detection circuit and the incoming call indicating light.

8. The mobile phone accessory of claim 4, wherein a cover plate is provided for protection to the at least one battery, the incoming call detection circuit and the incoming call indicating light.

9. The mobile phone accessory of claim 1, wherein the incoming call indicating light is located adjacent to the transparent or translucent plate such that light emitting from the incoming call indicating light passes through the transparent or translucent plate.

10. The mobile phone accessory of claim 2, wherein the incoming call indicating light is located adjacent to the transparent or translucent plate such that light emitting from the incoming call indicating light passes through the transparent or translucent plate.

11. The mobile phone accessory of claim 3, wherein the incoming call indicating light is located adjacent to the transparent or translucent plate such that light emitting from the incoming call indicating light passes through the transparent or translucent plate.

12. The mobile phone accessory of claim 4, wherein the incoming call indicating light is located adjacent to the transparent or translucent plate such that light emitting from the incoming call indicating light passes through the transparent or translucent plate.

13. The mobile phone accessory of claim 5, wherein the incoming call indicating light is located adjacent to the transparent or translucent plate such that light emitting from the incoming call indicating light passes through the transparent or translucent plate.

14. The mobile phone accessory of claim 6, wherein the incoming call indicating light is located adjacent to the transparent or translucent plate such that light emitting from the incoming call indicating light passes through the transparent or translucent plate.

15. The mobile phone accessory of claim 7, wherein the incoming call indicating light is located adjacent to the transparent or translucent plate such that light emitting from the incoming call indicating light passes through the transparent or translucent plate.

16. The mobile phone accessory of claim 8, wherein the incoming call indicating light is located adjacent to the transparent or translucent plate such that light emitting from the incoming call indicating light passes through the transparent or translucent plate.
